(19) United States
(12) Patent Application Publication
(10) Pub. No.: US 2003/0046314 A1
(43) Pub. Date: Mar. 6, 2003

(54) Text processing device, text processing method and program therefor

(76) Inventor: Hidekazu Morooka, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/152,025

(22) Filed: May 22, 2002

(30) Foreign Application Priority Data
May 31, 2001 (JP) 163760/2001 (PAT.
Apr. 18, 2002 (JP) 115941/2002 (PAT.

(51) Int. Cl. G06F 15/00; G06F 17/24

(52) U.S. Cl. 707/500; 707/530; 707/531

(57) ABSTRACT

It is an object of the present invention to achieve high quality document output without garbled text by specifying an optimum typeface for each character in a paragraph or for each paragraph in a document such as tagged document by using typeface information. In order to achieve the object, according to the present invention, there is provided a text processing device comprising an input unit for inputting a document including typeface attributes and text, a specifying unit for specifying a font based on the typeface attribute included in the document input by the input unit, installed fonts, and a text code of the text, and an output unit for outputting characters of the text by using the font specified by the specifying unit.

### BACKGROUND OF THE INVENTION

1. Field of the Invention

The present invention relates to a text processing device, a text processing method and a text processing program for outputting a document with tags, which can display input multiple languages by using multiple device installed typeface groups installed in a predetermined device.

2. Description of the Related Art

Hitherto, when text in a tagged document, such as HTML/XLM file, created by using a personal computer (PC) is displayed or is printed, a typeface attribute specified within the document is used to determine a typeface and to display the text.

However, with the development of the Internet, the document display and printing need to be globally compliant. Some text data required for a specified typeface may not exist when a typeface is only specified based on the typeface name and a characteristic of the character shape, which may cause garbled or hidden text. It is significantly inconvenient.

### SUMMARY OF THE INVENTION

The present invention was made in order to overcome the above problem. It is an object of the present invention to achieve high quality document output without garbled text by specifying an optimum typeface for each character in a paragraph or for each paragraph in a document such as a tagged document by using typeface information. In order to achieve the object, according to the present invention, there is provided a text processing device including an input unit for inputting a document having a typeface attribute and text, a specifying unit for specifying a font based on the typeface attribute included in the document input by the input unit, installed fonts, and a text code of the text, and an output unit for outputting characters of the text by using the font specified by the specifying unit.

Further objects, features and advantages of the present invention will become apparent from the following description of the preferred embodiments (with reference to the attached drawings).

### BRIEF DESCRIPTION OF THE DRAWINGS

FIG. 1 is a block diagram for explaining the construction of an information processing system to which a text output control device and a text processing device according to a first embodiment of the present invention can be applied.

FIG. 2 is a diagram for explaining the construction of memory to be assigned to RAM in the information processing system shown in FIG. 1.

FIG. 3 is a block diagram showing the basic configuration of an output device system to which the output device according to the first embodiment of the present invention can be applied.

FIG. 4 is a block diagram for describing data processing unit in a printing system to which the text output control device, the text processing device and the printing device according to the present invention are applied.

FIG. 5 is a block diagram showing an example of a network system to which the present invention can be applied.

FIGS. 6(A) and 6(B) are diagrams showing a processing example where a first tagged document is processed in the information output system according to the present invention.

FIG. 7 is a flowchart showing an example of first data processing in the text output control device and the text processing device according to the present invention.

FIG. 8 is a flowchart showing an example of second data processing in the text output control device and the text processing device according to the present invention.

FIG. 9 is a flowchart showing an example of third data processing in the text output control device and the text processing device according to the present invention.

FIG. 10 is a diagram showing a processing example where a second tagged document is processed in the information output system according to the present invention.

FIG. 11 is a flowchart showing an example of fourth data processing in the text output control device and the text processing device according to the present invention.

FIG. 12 is a flowchart showing an example of fifth data processing in the text output control device and the text processing device according to the present invention.

FIG. 13 is a diagram for explaining a memory map of a memory medium for storing different kinds of data processing programs, which can be read by an information processing system to which the text output control device and the text processing device according to the present invention can be applied.

### DESCRIPTION OF THE PREFERRED EMBODIMENTS

First Embodiment

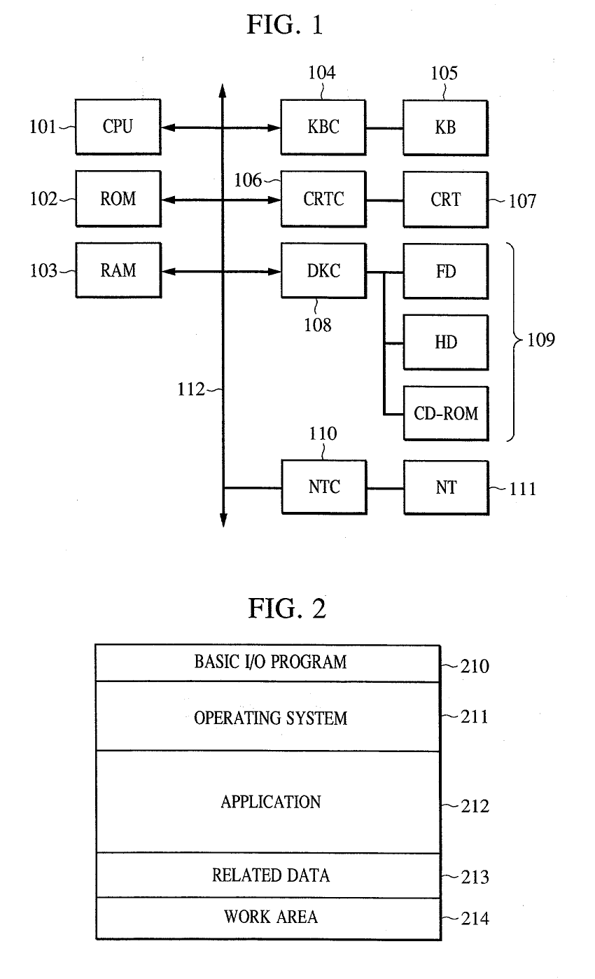

FIG. 1 is a block diagram for explaining the construction of an information processing system to which a text output control device and a text processing device according to a first embodiment of the present invention can be applied. This system may be a Japanese word processor or may be a system such as a workstation and a personal computer.

FIG. 1 includes a central processing unit (CPU) 101, a read-only memory, ROM, 102, a random access memory (RAM) 103, a keyboard control portion (KBC) 104, a keyboard (KB) 105, a display control portion (CRTC) 106, a display device (CRT) 107, a disk control portion (DKC) 108, an external memory device 109, a network control portion (NTC) 110, a network device (NT) 111, and a system bus 112. The central processing unit (CPU) 101 performs control over the device and computing processing. The ROM 102 stores a system start program to be executed by the CPU 101, text pattern data for text conversion, and so on.

The RAM 103 temporally stores data to be used for computation by the CPU 101 and the computed results by the CPU 101. The KBC 104 receives key input data (text code and/or control code) from KB 105 and transmits them to the CPU 101.

The CRTC 106 reads display information, that is bit map images converted from text data, which is stored in the RAM 103 and transfer it to the CRT 107. The CRT 107 receives and displays on the display screen the bit map images from the CRTC 106. The DKC 108 controls data transmission and so on by the external memory device 109.

The external memory device includes a floppy disk device (FD), a hard disk device (HD), a CD-ROM or the like, programs and data are stored in the external memory device 109, and the CPU 101 refers to the stored data as necessary, or loads them to the RAM 103. The NTC 110 performs operational control over the NT 111. The system bus 112 transfers data between the above components.

FIG. 2 is a diagram for explaining a construction of memory to be assigned to the RAM 102 in the information processing system shown in FIG. 1.

Notable, the basic I/O program, an operating system, such as the Window system, and an application, that is processing of the present invention, are operated such that this system can run.

In this embodiment, the basic I/O program is stored in the ROM 102 shown in FIG. 1. The operating system is stored in the external memory device 109, such as a hard disk, shown in FIG. 1. Then, when the power is turned on, the operating system is read from the HD into a predetermined area of the RAM 103 by means of an initialize program loading (IPL) function in the basic I/O program in order to start the operation.

A program and related data for implementing functional processing according to the present invention are supplied from the external memory device 109 such as the FD or CD-ROM shown in FIG. 1. Then, the program and the related data are installed from the FD or CD-ROM shown in FIG. 1 into the HD once such that they can be loaded from the HD to the RAM 103 for execution. Alternatively, without the installation in the HD, the program and the related data can be loaded from the FD or the CD-ROM to the RAM 103 directly for execution.

FIG. 2 shows a basic I/O program 210, an operating system 211, an application 212, related data 213, and work memory 214. In FIG. 2, the basic I/O program 210 is loaded from the ROM 102 and is ready for the execution. The operating system such as the Window system is loaded from a RAM 103 and is ready for the execution.

The application 212 includes programs corresponding to steps shown in a flowchart, which will be described later. The programs are loaded to the RAM 103 and are ready for the execution.

The related data 213 is loaded to the RAM 103 and is ready for the execution. The work area 214 is used by and is dynamically divided and assigned for programs.

FIG. 3 is a block diagram showing the basic system configuration of an output device to which the output device according to the first embodiment of the present invention can be applied. This output device may be a laser beam printer, a bubble jet printer or a thermal transfer output machine, for example.

FIG. 3 includes a central processing unit (CPU) 301, a ROM 302, a RAM 303, a printer control portion (PRTC) 304, a printer device (PRT) 305, a system bus 308, a network control portion (NTC) 306, and a network device (NT) 307. The CPU 301 controls over the whole device, performs computing processing and so on.

The ROM 302 is a memory area for storing a system start program, character pattern data and so on. The RAM 303 is a data memory area without any use limit and programs and data are loaded and are executed for each different processing.

The PRTC 304 controls printing processing by the PRT 305. The system bus 308 is a path through which data is passed between the above components. The NTC 306 controls operations by the NT 307.

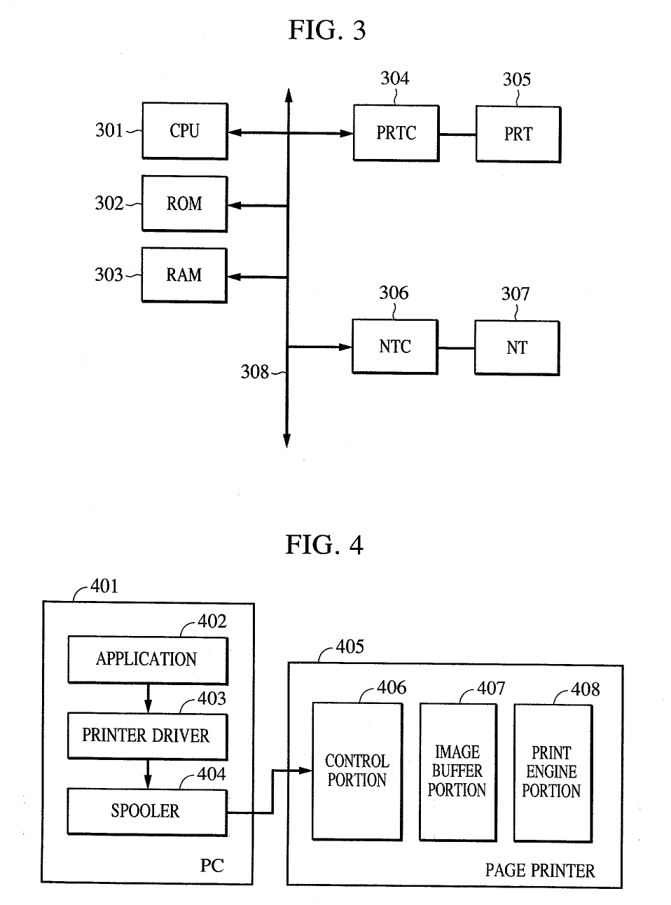

FIG. 4 is a block diagram for describing data processing unit in a printing system to which the text output control device, text processing device and the printing device according to the present invention are applied.

FIG. 4 includes a PC 401, an application program (application) 402, a printer driver program (printer driver) 403, a spooler program 404, a page printer (printer) 405, a control portion 406, an image buffer portion 407, a control portion 406, and a printing engine portion 408. The PC 401 may be a Japanese word processor or may be a system using a unit such as a workstation and a personal computer. The application 402 creates document files.

The printer driver 403 is used for performing output processing. A drawing instruction, for example, from the application 402 is converted to analyzable printing data by the printer 405. The spooler program 404 spools the output from the printer driver 403 once.

The control portion 406 analyzes a command output from the printer driver 403 and creates a bit map image. The bit map image created by the control portion 406 is expanded in the image buffer portion 407. The printing engine portion 408 prints on paper for readout the image expanded in the image buffer portion 407.

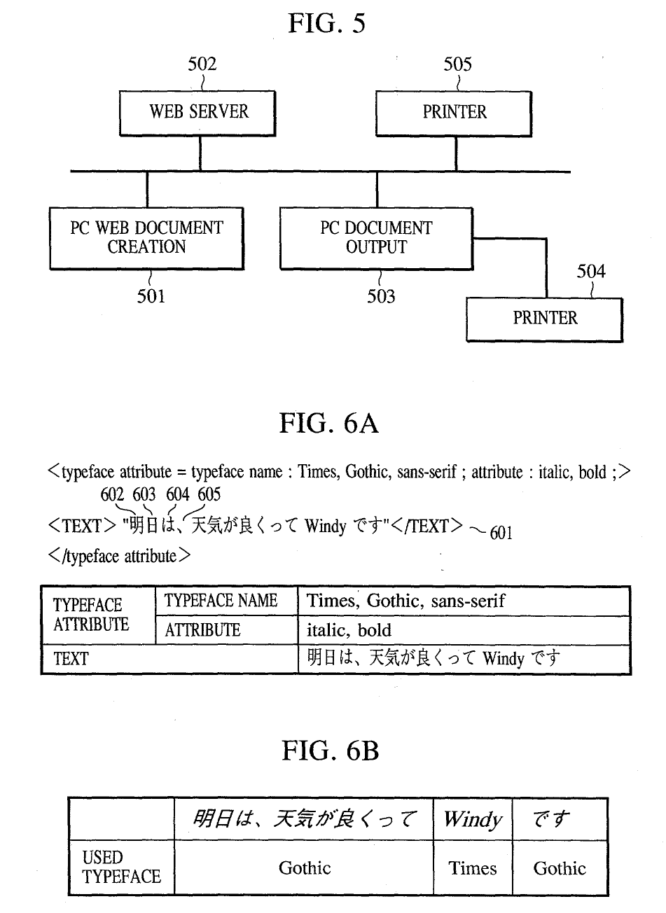

FIG. 5 is a block diagram showing an example of a network system to which the present invention can be applied. The example corresponds to an example of the system, which is configured such that multiple PC's, a server and a printer can communicate over a network by using a predetermined protocol.

FIG. 5 includes a PC 501 for creating documents, a Web server (server) 502 for storing Web documents residing on the Internet, a PC 503 for displaying Web documents, a local printer 504 and a network printer 505. The PC 501 log creates documents by using application software and sends files embedding font information for the documents. The PC 501 has the hardware configuration as shown in FIG. 1.

The server 502 may be a system using a unit such as a workstation and a personal computer.

The PC 503 controls the local printer 504 or the network printer 505 to print out displayed Web documents.

The printer 504 is a local printer directly connecting to the PC 503 via a predetermined interface. The network printer 505 can receive and output Web documents from the PC 501 or 503 or the server 502.

FIGS. 6(A) and 6(B) are diagrams showing a processing example where a first tagged document is processed in the information output system according to the present invention. FIG. 6(A) shows an example of a tagged document while FIG. 6(B) corresponds to an example of the printed output of the document in FIG. 6(A).

In FIG. 6(A), a <TEXT> tag indicating text is added a <typeface attribute> tag indicating the typeface attribute such that the typeface to be used when the text is displayed can be specified.

Text between tags <TEXT> and </TEXT> is called paragraph, and a typeface is matched to each character in a paragraph based on the order of the appearance of typeface names in a typeface attributes.

For example, in the example in FIG. 6(A) and in the example below, the matching of the typefaces is performed in order of the appearance of typeface names, which are Times (Western-language font) and Gothic (Japanese-language font):

<typeface attribute=typeface name: Times, Gothic, sans-serif; attribute: italic, bold;>

<TEXT>“a paragraph 601 in FIG. 6(A)”</TEXT>

</typeface attribute>

The part “windy” in the paragraph is displayed in Times and the other part is displayed in Gothic, which is a Japanese-language font.

FIG. 6(B) represents an output image of the document shown in FIG. 6(A).

A document includes paragraphs, typeface attribute information and image data. The method of outputting image data is not especially described herein. Multiple paragraphs constructing the document correspond to one piece of typeface attribute information.

As shown in FIG. 6(A), the typeface attribute information includes an attribute (such as italic and bold) indicating a form of a typeface and a typeface name thereof. Multiple candidate typeface names can be set. However, the first written typeface name has a priority for the typeface name-based matching.

In other words, with reference to the example shown in FIGS. 6(A) and 6(B), when any one of typefaces of Times, Gothic and sans-serif is available, Times is matched to the character.

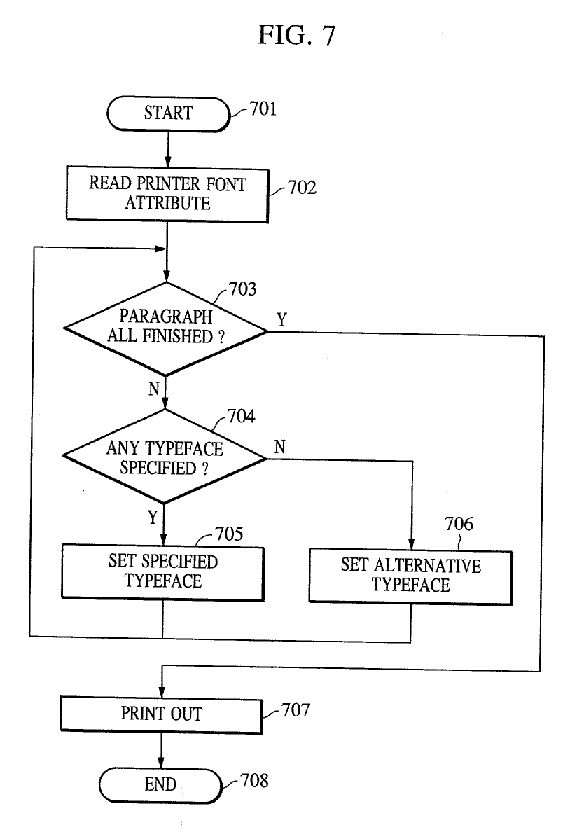

FIG. 7 is a flowchart showing an example of first data processing in the text output control device and the text processing device according to the present invention. The flowchart includes steps (701) to (708). This processing is implemented by the PC 503 or the printer 505 shown in FIG. 5.

Once processing starts in a step (701), fonts embedded in a device available for document output are read from all of font data formats registered in the device onto memory as typeface attribute information is a step (702).

The fonts may be registered in a HD of the device or may be registered in a memory such as a ROM/RAM. The memory includes typeface attribute information such as typeface names, attribute data, a type of text codes encoding (will be referred simply as Encoding in tables) and corresponding text code ranges. The corresponding text code ranges correspond to types of text code encoding. For example, if the type of text code encoding is EUC, the Chinese character code part is represented by 0×A1A1 to 0×FEFE. If it is the JIS code, the Chinese character code part is represented by 0×2121 to 0×7E73. The text code ranges may be standardized to a type of encoding such as unicode for the registration on the memory. A type of encoding registered in embedded font data may be used for the registration on the memory. An example of data formats read onto the memory will be described below:

| | | | CORRESPONDING |
|---|---|---|---|
| TYPEFACE | ATTRIBUTE | | TEXT CODE |
| NAMES | DATA | ENCODING | RANGES |
| CanonBoldltalic | Bold W3, | UTF-8 | 0 × 20-0 × 7E |
| | Italic | | (Alphabet) |
| NonacMediauBold | Bold W5 | UTF-8 | 0 × 20-0 × 7E |
| | | | (Alphabet) |
| : | : | : | : |
| Times | W5 | UTF-16 | 0 × 20-0 × 7E |
| | | | (Alphabet) |
| Gothic | W5 | JIS | 0 × 20-0 × 7E |
| | | | (Alphabet) |
| | | | 0 × 2121-0 × 7E73 |
| | | | (Chinese character) |
| CanonW7 | Bold W7 | UTF-8 | 0 × 20-0 × 7E |
| | | | (Alphabet) |

Attribute data may be effective if it is defined by a keyword such as Italic and Bold, which indicate shapes of typefaces, or it is determined by numerals indicating shapes of typefaces as PANOSE data. Each text code range is registered together with a type of text encoding. This data may be used as is if a typeface data is defined. If it is not defined, INDEX of typeface data may be read on the present system side and be registered in the typeface attribute information. In the step (703), whether all of the paragraphs within the document are matched with device embedded fonts is determined (this determination processing is performed by the CPU 101 shown in FIG. 1 if it is a PC or by the CPU 301 shown in FIG. 3 if it is a printer). If it is determined that all of paragraphs are matched with device embedded fonts, the processing goes to the step (707), where the print-out processing is performed. In the step (708), the processing ends.

On the other hand, if it is determined that all of paragraphs in the document are not matched with device embedded fonts, whether any typeface name is specified in the typeface attribute information is determined (704). If it is determined that a typeface name is specified, the processing goes to the step (705), where processing for setting the specified typeface is performed. Then the processing returns to the step (703). If it is determined that no typeface is specified, the processing goes to the step (706), where an alternative typeface is specified. Then, the processing returns to the step (703).

Notably, the step (703), where whether the all paragraphs are matched or not is determined may be performed on one document or may be performed on each page.

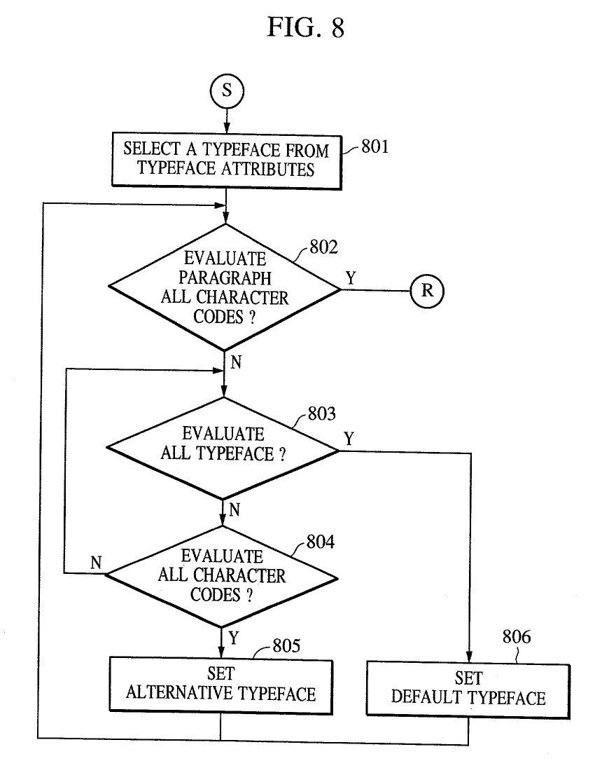

FIG. 8 is a flowchart showing an example of second data processing in the text output control device and the text processing device according to the present invention. The second data processing corresponds to a detail of the processing for setting an alternative typeface in the step (706) shown in FIG. 7. The processing includes steps (801) to (806).

First of all, in the step (801), data (such as italic and bold) indicating a characteristic of a character shape in the typeface attribute data is used to select data on like-shaped characters from printer-installed fonts (which are stored in the ROM 302 shown in FIG. 3). Then, candidate typefaces are listed up and are given priorities. A case where three typefaces, which will be described below, are registered as device-embedded fonts and typeface attributes defined in a paragraph have attribute name: not specified and attribute: Bold W8 will be described by using a specific example regarding priorities of typefaces. In this case, the matching cannot be performed based on typefaces. Therefore, the matching is performed based on attributes. In this case, the paragraph attribute and the embedded font attribute are weighted for the matching. For example, if the difference between the weight, which is set for the paragraph attribute, and the weight, which is defined for the embedded font attribute, is one or below, two or above, and three or above, 10, 5 and one points are added, respectively. This addition is also performed based on other attributes such as italic. The result is registered in typeface attribute data as a matching level, and attributes having higher values are sorted sequentially and are listed up. Those at higher levels are given priorities and are sequentially matched to text code ranges and so on in order to determine candidates. Naturally, the evaluation on matching levels for attributes is also effective for a case where no typeface name is defined in the typeface attribute defined for the paragraph.

| | | | | TEXT | MATCH- |
|---|---|---|---|---|---|
| PRIOR- | TYPEFACE | ATTRI- | | CODE | ING |
| ITIES | NAMES | BUTES | ENCODING | RANGES | LEVELS |
| 3 | Canon 1 | Bold | UTF-8 | 0 × 00- | 1 |
| | | W3 | | 0 × FF | |
| 2 | Nonac 2 | Bold | UTF-8 | 0 × 00- | 5 |
| | | W5 | | 0 × FF | |
| 1 | Canon 3 | Bold | UTF-8 | 0 × 00- | 10 |
| | | W7 | | 0 × FF | |

Next, in the step (802), it is determined whether or not the matching evaluation between device fonts and typefaces is performed on all text codes within the paragraph. If it is determined that the all evaluations end, the processing returns (RETURN) to the step (703) shown in FIG. 7. If it is determined that not all of text code evaluations are finished, the processing goes to the step (803) by bringing text codes to be evaluated for each character. Now, a method of determining a type of text code will be described. A type of text code encoding used within a paragraph is defined in a paragraph document as a definition of the document. Therefore, if the text code of the paragraph and the type of encoding for embedded fonts are different, code conversion is performed to determine the text code. As the method, in order to the character code in memory as typeface attribute information for the embedded fonts, when text code ranges corresponding to the embedded fonts are standardized to a type of encoding, such as unicode, for the registration and when the type of encoding within the paragraph and the type of encoding in the registered typeface attributes are different, the code conversion may be performed for the text code evaluation. Alternatively, when the text code ranges are registered in the typeface attribute information based on the type of encoding described in embedded font data and when the text code within the paragraph and the type of encoding described in the typeface attribute information are different, the code conversion may be performed for the determination. Naturally, when the type of encoding in the typeface attribute information and the type of encoding within the paragraph are the same, the evaluation is performed without text code conversion.

Then, in the step (803), it is determined whether or not the matching evaluations of all typefaces listed up in the step (801) with respect to text codes are finished. If it is determined that the evaluations on all of the typefaces are finished, the processing goes to the step (806). There, a typeface is specified such that the text output can be performed by using a typeface (called default typeface herein) registered in the system in advance. Then, the processing returns to the step (802).

On the other hand, in the step (803), if it is determined that the evaluations with respect to all of the typefaces are not finished, the processing goes to the step (804). There, it is determined whether or not a target text code is included in the listed typefaces. If it is determined that the target text code is included in the listed typefaces, the processing goes to the step (805). There, a typeface is specified (set) such that the determined text can be output by using the determined typeface. Then, the processing returns to the step (802). Based on the setting, the text is output by using the specified typeface. If the specified typeface takes the characteristic of attribute data into consideration, the printing processing is performed by turning OFF corresponding data among attribute data. In more specific example, if the attribute data of a paragraph is specified as Italic and Bold and if the selected typeface is italic, the conflict between the typeface selected in printing and the attribute data is taken. Then, the processing is performed such that the double typeface attributes cannot be applied. Thus, if the selected typeface is Italic, only Bold processing is performed on the typeface.

On the other hand, in the step (804), if it is determined that the subject text code is not included in the listed typefaces, the processing goes to immediately before the step (803) in order to check the text code with respect to a typeface having the next priority.

The default typeface does not correspond to a character-shape data (such as Italic and Bold) in the typeface attributes. However, a typeface having the text code may be selected and be used from the device embedded typefaces.

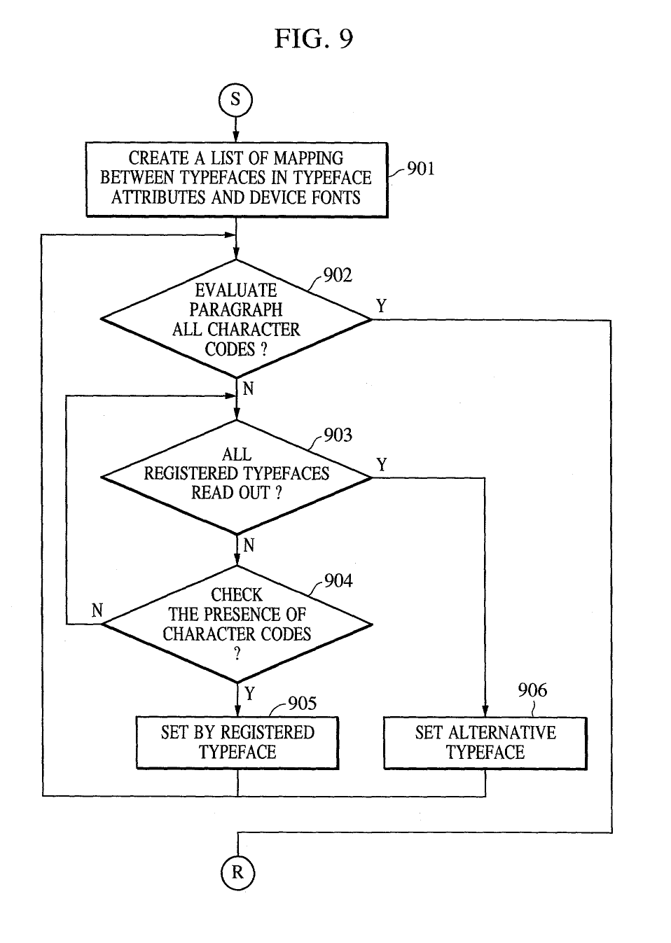

FIG. 9 is a flowchart showing an example of third data processing in the text output control device and the text processing device according to the present invention. The third data processing corresponds to a detail of the processing for setting a typeface specified in the step (705) shown in FIG. 7. The processing includes steps (901) to (906).

First of all, in the step (901), typefaces written in the typeface attribute are mapped to device fonts, and a list is created which lists the typefaces in the order of priority. In the example shown in FIG. 6(A), when there are Times and Gothic in the device embedded fonts (printer built-in fonts), The typeface on the left in FIG. 6(A) has a higher priority, the list is created where Times has the first priority and Gothic has the second priority.

| PRIOR- | TYPEFACE | NUMBER OF | ATTRI- | | |
|---|---|---|---|---|---|
| ITIES | NAMES | CHARACTERS | BUTES | ENCODING | TEXT CODE RANGES |
| 2 | Gothic | 8 | W5 | JIS | 0 × 20-0 × 7E |
| | | | | | (Alphabet) |
| | | | | | 0 × 2121-0 × |
| | | | | | 7E73 (Chinese |
| | | | | | character) |
| 1 | Times | 5 | W5 | UTF-8 | 0 × 20-0 × 7E |
| | | | | | (Alphabet) |

The creation of the list here will be described by using a specific example where the typeface name defined in the paragraph is “Nonac”. When four typefaces listed in a table below are registered in the device embedded fonts and when the typeface name defined as the paragraph is “Nonac”, it is matched with a typeface name in the device embedded fonts. In this case, the output typeface is one having the name completely matching with “Nonac”, which is the first candidate. The next candidate is one belonging to the same family and having the name “Nonac” in the typeface name. Here, typefaces having an identical character string are regarded as typefaces in the same family. Keywords, such as Italic, Bold and BoldItalic, in the typeface names are focused and are weighted to give priorities to candidates, respectively. As an example, the candidates for the “Nonac” typeface have the priorities of Bold>Italic>BoldItalic. The priority in this typeface family depends on the implemented system. If there is no matching in the typeface names, the output typeface is one other than the matching candidates and the priority list is not applicable thereto.

| PRIOR- | TYPEFACE | NUMBER OF | ATTRI- | | TEXT CODE |
|---|---|---|---|---|---|
| ITIES | NAMES | CHARACTERS | BUTES | ENCODING | RANGES |
| 4 | NonacBoldItalic | 15 | Italic, | UTF-8 | 0 × 00-0 × ff |
| | | | Bold | | |
| 3 | NonacItalic | 11 | Italic | UTF-8 | 0 × 00-0 × ff |
| 2 | NonacBold | 9 | Bold | UTF-8 | 0 × 00-0 × ff |
| 1 | Nonac | 5 | | UTF-8 | 0 × 20-0 × ff |

Next, in the step (902), it is determined whether or not the evaluation is performed on all characters in the paragraph. If it is determined that the evaluation is performed on all characters, the processing returns to immediately before the step (703). If it is determined that the evaluation is still in the middle, the processing goes to the step (903).

Then, in the step (903), it is determined whether or not all of the typeface names in the typeface list created in the step (901) are evaluated when one typeface name is read out from the list created in the step (901). If it is determined that all of the typeface names in the created typeface list are read out, it is determined that the typeface name registered in the typeface attribute cannot be handled. Then, the processing goes to the step (906).

In the step (906), an alternative typeface is set. Then, the processing returns to the step (902). The processing in the step (906) has the same function as that of the step (706), and the detail is the same as the flow shown in FIG. 8.

On the other hand, in the step (903), if it is determined that all of the typeface names in the created typeface list are not evaluated, it is determined in the step (904) whether or not a specified text code exists in the read device embedded typefaces. If it is determined that the text code does not exist, the processing returns to immediately before the step (903) to check a text code with respect to the next typeface. For example, in the example in FIG. 6(A), based on the list created in the step (901), it is determined whether or not the text code for a character 602 in FIG. 6(A) is in the Times text code range having the first priority. Since the text code for the character 602 in FIG. 6(A) is not in the Times text code range, it is determined next that whether or not the text code for the character 602 in FIG. 6(A) is in the Gothic text code range having the second priority. Since the text code for the character 602 in FIG. 6(A) is in the Gothic text code range, the text code for the character 602 in FIG. 6(A) is specified for the output in Gothic. Subsequently, text codes for a character 603 in FIG. 6(A), a character 604 in FIG. 6(A), a character 605 in FIG. 6(A) and so on are processed in the same manner. Next, it is determined whether or not the text code for “w” is in the Times text code range. Since the text code for “w” is in the Times text code range, the text code for “w” is specified in Times for the output. Notably, since Times and Gothic are not the Italic and Bold family typefaces, the italic variation and the Bold variation are also specified for the times and Gothic font data. Based on the variation specification, text in Times and Gothic subject to the Italic variation and Bold variation is output.

On the other hand, if it is determined in the step (904) that the presence of the text code is identified, the processing goes to the step (905), where a registered typeface name is specified that chat the identified text is output by using the specified typeface. Then, the processing returns to the step (902). By using the above steps, the controller portion 406 creates a command for specifying fonts to be used for outputting each character. This command may give an attribute for specifying the Italian variation or the Bold variation to each text code. Alternatively, this command may insert a switching command between text codes for switching between typeface names, Italian variation and Bold variation and so on. Image data is created in the image buffer portion 407 from the created command by using printer fonts, and the printing is performed by the print engine portion 408 based on the created image data.

While the example where the program is loaded to the RAM 103 and is executed thereon in the first embodiment, the program and related data from an FD, which is the external memory device 109, may be stored (or installed) in the HD once. Then, the program may be loaded from the HD to the RAM 103 to operate the program.

The medium for storing the program may be a CD-ROM, an IC memory card and so on in addition to an FD. The program may be stored in the ROM 102, and it may be configured to be a part of a memory map such that it can be executed by the CPU 101 directly.

Second Embodiment

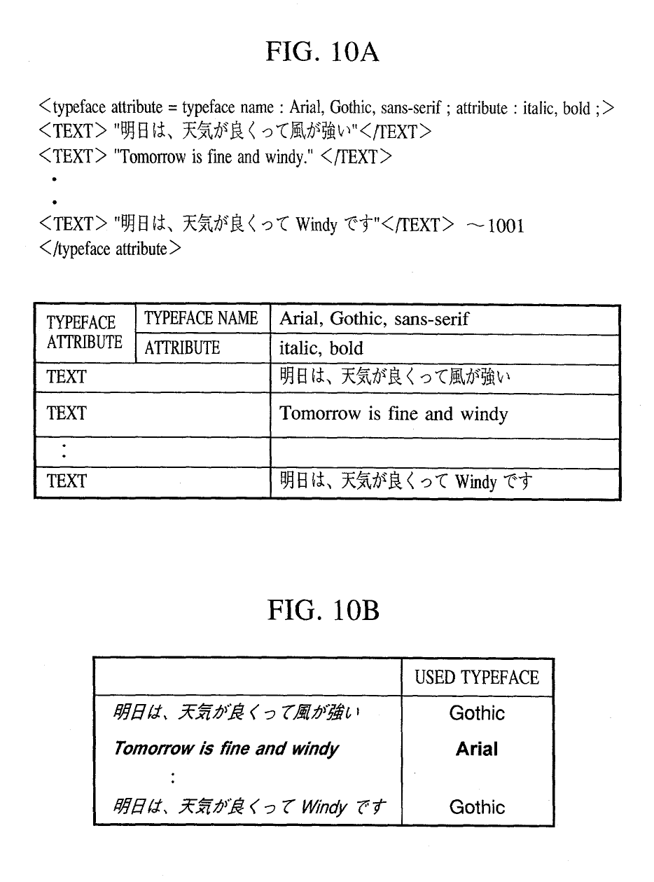

FIGS. 10(A) and 10(B) are diagrams showing a processing example where a second tagged document is processed in the information output system according to the present invention. FIG. 10(A) shows a tagged document example while FIG. 10(B) corresponds to a printed output example of the document in FIG. 10(A).

In FIGS. 10(A), a <TEXT> tag indicating text is added a <typeface attribute> tag indicating-the typeface attribute such that the typeface used when the text is displayed can be specified.

Text between tags <TEXT> and </TEXT> is called paragraph, and text in the paragraph is handled by one typeface specified by the typeface attribute.

For example, in the example in FIG. 10(A) the paragraph below is displayed in Gothic:

<TEXT>“a paragraph 1001 in FIG. 10(A)”</TEXT> The paragraph below is displayed in Arial.

<TEXT>“Tommorrow is fine and windy.”</TEXT> The document includes the paragraph, typeface attribute information and image data. The method of outputting image data is not especially described herein. Multiple paragraphs constructing the document correspond to one piece of typeface attribute information.

The typeface attribute information includes an attribute (such as italic and bold) indicating a form of a typeface and a typeface name thereof as shown in FIG. 10. Multiple candidate typeface names can be set. However, the first written typeface name has a priority for the matching based on typeface names.

In other words, with reference to the example shown in FIGS. 10(A), when any one of typefaces of Arial, Gothic and sans-serif is available, Arial is matched to the paragraph.

In this embodiment, unlike the typeface setting processing performed on documents according to the first embodiment, Japanese text is output in Gothic when Western-language text is partially included in the document. A document only in Western language is output in Arial.

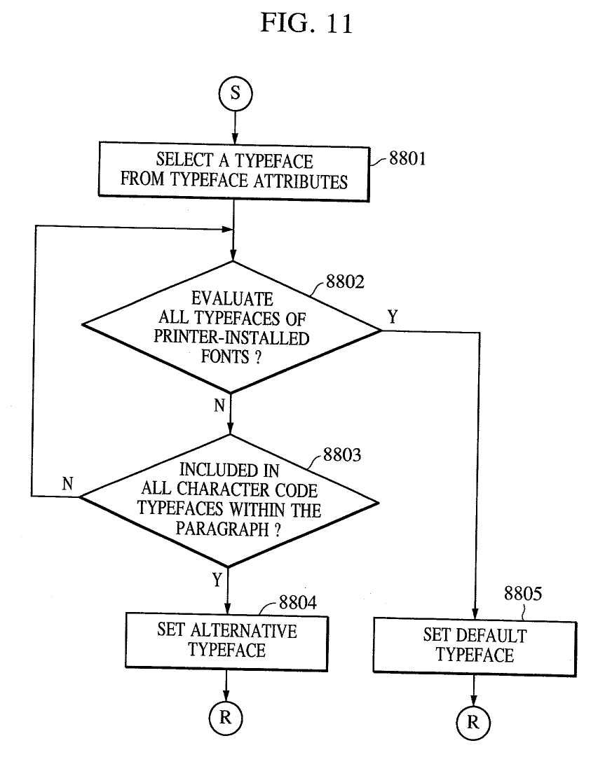

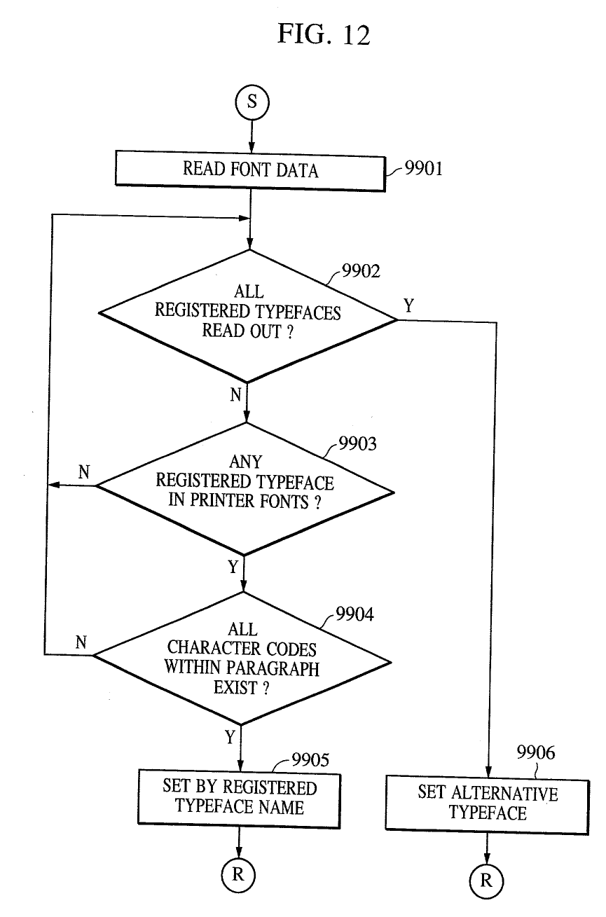

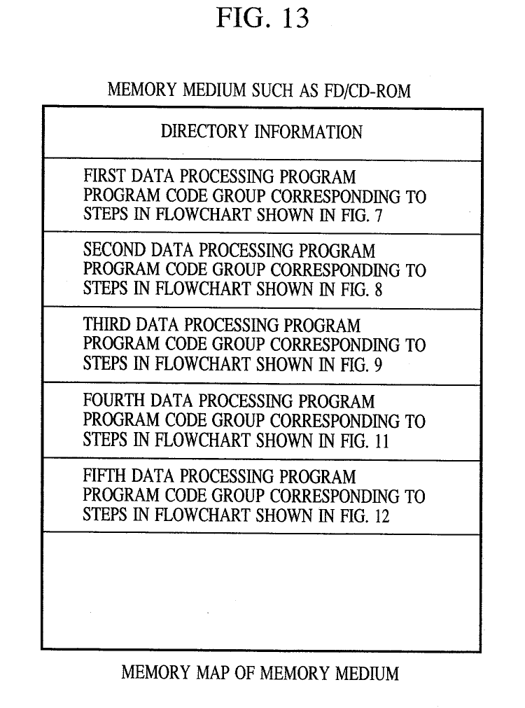

Basic steps for the document output are same as the steps shown in FIG. 7 according to the first embodiment, and the detail description on the steps is omitted here. Specified typeface setting processing and alternative typeface setting processing will be described with reference to flowcharts shown in FIGS. 11 and 12.

FIG. 11 is a flowchart showing an example of fourth data processing in the text output control device and the text processing device according to the present invention. The fourth data processing corresponds to a detail of the processing for setting an alternative typeface in the step (706) shown in FIG. 7. The processing includes steps (8801) to (8805).

First of all, in the step (8801), data (such as italic and bold) indicating a characteristic of a character shape in the typeface attribute data is used to select data -on like-shaped characters from printer installed fonts.

Then, candidate typefaces are listed up and are given priorities.

Next, in a step (8802), it is determined whether or not all typefaces listed up in the step (8801) are evaluated. If it is determined that the evaluations on all of the typefaces are finished, the processing goes to a step (8805). If it is determined that unevaluated typefaces still remain, the processing goes to the step (8803) in order to evaluate candidate typefaces. There, it is determined whether all of the text codes in the paragraph are included in the candidate typeface information. If it is determined that they are included in the candidate typefaces, the typeface information is determined as an alternative typeface in the step (8804). Then, the processing returns.

On the other hand, in the step (8803), when it is determined that all of the text codes in the paragraph are not included in the candidate typefaces, the processing returns immediately before the step (8802) to evaluate the next candidate typeface.

On the other hand, when it is determined that all evaluations are performed in the step (8802), that is, when no applicable typeface can be found in the candidate typefaces, a typeface is specified such that the text output can be performed by using a typeface (called default typeface herein) registered in the system in advance. Then, the processing returns. For the default typeface, a typeface compliant with all of the text codes used in the paragraph may be selected from the device embedded typefaces.

Thus, a typeface is specified so as to match with paragraphs in the document. The evaluated paragraph is output by using the alternative typeface in order to output the document with preventing the characters from getting garbled.

FIG. 12 is a flowchart showing an example of fifth data processing in the text output control device and the text processing device according to the present invention. The fifth data processing corresponds to a detail of the processing for setting another specified typeface in the step (705) shown in FIG. 7. The processing includes steps (9901) to (9906).

First of all, in the step (9901), a typeface name of the device embedded font (called “device font” herein after) is read and the read typeface name is registered in the work memory.

Then, in the step (9902), it is determined whether or not all of the typeface names written in the typeface attribute are read out. If it is determined that all of the typeface names written in the typeface attribute are finished to read out, the processing goes to the step (9906). There, an alternative typeface is set, and the processing returns. Notably, the processing in the step (9906) is the same as the processing in a series of the steps (8801) to (8805) shown in FIG. 11.

On the other hand, in the step (9902), if it is determined that not all of the typeface names written in the typeface attribute are read out, the typeface names read out in the step (9901) and the typeface names read out in the step (9902) are compared in the step (9903) to determine whether or not there is the same typeface name (whether or not there is any typefaces identical to the typeface registered in the printer font). If it is determined that there is not the same typeface name, the processing returns to the step (9902).

On the other hand, in the step (9903), if it is determined that there is the same typeface name, it is determined in the step (9904) whether or not all of the text codes for the text in the specified paragraph exist in the matched device font data. If it is determined that not all of the text codes in the text within the specified paragraph exist therein, the processing returns to the step (9902). If it is determined all of the text codes in the text within the specified paragraph exist therein, a typeface is specified in the step (9905) such that the found typeface can match with the specified paragraph. Then, the processing returns.

Thus, the paragraph shown in FIG. 10(A) is all output normally by using the specified typeface without character-garbling.

While the example where the program is loaded to the RAM 103 and is executed thereon in the second embodiment, the program and related data from an FD, which is the external memory device 109, may be stored (or installed) in the HD once. Then, the program may be loaded from the HD to the RAM 103 to operate the program.

The medium for storing the program may be a CD-ROM, an IC memory card and so on in addition to an FD. The program may be stored in the ROM 102, and it may be configured to be a part of a memory map such that it can be executed by the CPU 101 directly.

According to this embodiment, when a tagged text document created by a PC is displayed or printed in accordance with a typeface attribute specified within the document, the typeface attribute is used to select a typeface including the text code from device (the PC or printer) installed font. Thus, a high-quality document system can be achieved without any character-garbling.

The construction where the first embodiment and the second embodiment are combined in an effective manner is applicable to the scope of the present invention.

The construction of a data processing program, which can be read by an information processing system to which the text output control device and the text processing device according to the present invention can be applied, will be described with reference to a memory map shown in FIG. 13.

FIG. 13 is a diagram for explaining the program map of the memory medium for storing different kinds of data processing programs, which can be read by a information processing system to which the text output control device and the text processing device according to the present invention can be applied.

Though not shown in particular, information for managing programs stored in a memory medium, such as version information and the creator, may be stored therein. Further, information depending on the OS, for example, of the program reading device, such as icons for identifying programs, may be stored therein.

Data belonging to the programs are also managed under the directory. Furthermore, when a program for installing programs in a computer or programs to be installed therein are compressed, a program for expanding them may be stored.

Functions shown in FIGS. 7 to 9, 11 and 12 according to this embodiment may be performed by the host computer by using a program installed externally. In this case, the present invention can be applied to a case where information including the program is supplied to the output device from a memory medium such as a CD-ROM, a flash memory and an FD or from an external memory medium over a network.

In this way, the memory medium storing program codes for software for implementing the functions according to the embodiments may be supplied to a system or a device. Then, the computer (CPU or MPU) of the system or the device may read and execute the program codes stored in the memory medium. Thus, the object of the present invention can also be achieved.

In this case, the program codes themselves, which are read from the memory medium, implement the new function of the present invention, and the memory medium storing the program codes can construct the present invention.

The memory medium for supplying program codes may be floppy disks, hard disks, optical disks, magneto-optical disks, CD-ROM, CD-R, magnetic tapes, nonvolatile memory cards, ROM and EEPROM.

By executing program codes read by the computer, not only the function according to the above embodiments may be implemented but also a part or all of actual processing may be performed by the operating system (OS) running on the computer based on instructions of the program codes in order to implement the function of the above embodiments.

Furthermore, program codes read out from the memory medium-may be written in the CPU included in a function extension board inserted to the computer or included in a function extension unit connected to the computer, a part or all of actual processing may be performed by the CPU included in a function extension board inserted to the computer or included in a function extension unit connected to the computer based on instructions of the program codes in order to implement the function of the above embodiments.

As described above, according to the embodiments of the present invention, in the text output control device for causing a document with tags, which can display input multiple languages, to be output by using multiple device installed typefaces installed in a predetermined device, it is determined whether or not any typeface name is specified in read typeface attribute information. If it is determined that a typeface name is specified in the typeface attribute information, the same typeface name as the specified typeface name is selected from the device installed typefaces. Then, the selected typeface is specified as an output. typeface for the document. If it is determined that no typeface is specified in the typeface attribute information of the document, it is further determined whether or not there is an alternative typeface in the: device installed typefaces, which can be used for each character in the text data in the paragraph based on the attribute data in the typeface attribute information. Here, if it is determined that there is an alternative typeface, the alternative typeface is specified for each character as an output typeface candidate for the document. If it is determined that there are no alternative typefaces, an alternative default typeface is used as the output typeface candidate for the document. Thus, when a document without any specification for the typeface attribute is input, the text output from an output device may be prevented from getting garbled or lacked due to the lack of the typeface attribute. In addition, a text output-processing environment can be established flexibly as much as possible by using multiple typefaces installed in the output device.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A text processing device comprising:
input means for inputting a document including typeface attributes and text;
specifying means for specifying a font based on the typeface attribute included in the document input by the input means, installed fonts, and a text code of the text; and
output means for outputting characters of the text by using the font specified by the specifying mean.

2. A device according to claim 1, further comprising creating means for creating a list based on the typeface attributes included in the document input by the input means, wherein the specifying means specifies a font based on the list created by the creating means and the text code of the text.

3. A device according to claim 1, wherein the specifying means specifies a font for each character.

4. A device according to claim 1, wherein the specifying means specifies a font for each paragraph.

5. A device according to claim 1, wherein the typeface attribute includes a typeface name and an attribute.

6. A device according to claim 1, wherein the document includes a tagged document.

7. A device according to claim 1, wherein the specifying means selects a font in consideration with an order of specifying typeface attributes.

8. A device according to claim 1, wherein, when a typeface name is specified, the specifying means creates a list based on the typeface name and installed fonts and specifying a font based on the created list and the text code, and
wherein, when no typefaces are specified, the specifying means creates a list based on the attribute and stored fonts and specifies a font based on the created list and the text code.

9. A device according to claim 1, wherein, when a typeface name is specified, the specifying means creates a list based on the typeface name and installed fonts and wherein, when no fonts are specified based on the created list and the text code, the specifying means creates a list based on the attribute and stored fonts and specifies a font based on the created list and the text code.

10. A device according to claim 1, the output device includes a printer.

11. A text processing method comprising the steps of:
inputting a document including typeface attributes and text;
specifying a font based on the typeface attribute included in the document input by the input step, installed fonts, and a text code of the text; and
outputting characters of the text from an output device by using the font specified by the specifying step.

12. A method according to claim 11, further comprising the step of creating a list based on the typeface attributes included in the document input by the input step, wherein the specifying step specifies a font based on the list created by the creating step and the text code of the text.

13. A method according to claim 11, wherein the specifying step specifies a font for each character.

14. A method according to claim 11, wherein the specifying step specifies a font for each paragraph.

15. A method according to claim 11, wherein the typeface attribute includes a typeface name and an attribute.

16. A method according to claim 11, wherein the document includes a tagged document.

17. A method according to claim 11, wherein the specifying step selects a font in consideration with an order of specifying typeface attributes.

18. A method according to claim 11, wherein, when a typeface name is specified, the specifying step creates a list based on the typeface name and installed fonts and specifying a font based on the created list and the text code, and
wherein, when no typefaces are specified, the specifying step creates a list based on the attribute and stored fonts and specifies a font based on the created list and the text code.

19. A method according to claim 11, wherein, when a typeface name is specified, the specifying step creates a list based on the typeface name and installed fonts and wherein, when no fonts are specified based on the created list and the text code, the specifying step creates a list based on the attribute and stored fonts and specifies a font based on the created list and the text code.

20. A method according to claim 11, the output device includes a printer.

21. A text processing program comprising the steps of:
inputting a document including typeface attributes and text;
specifying a font based on the typeface attribute included in the document input by the input step, installed fonts, and a text code of the text; and
outputting characters of the text from an output device by using the font specified by the specifying step.

22. A program according to claim 21, further comprising the step of creating a list based on the typeface attributes included in the document input by the input step, wherein the specifying step specifies a font based on the list created by the creating step and the text code of the text.

23. A program according to claim 21, wherein the specifying step specifies a font for each character.

24. A program according to claim 21, wherein the specifying step specifies a font for each paragraph.

25. A program according to claim 21, wherein the typeface attribute includes a typeface name and an attribute.

26. A program according to claim 21, wherein the document includes a tagged document.

27. A program according to claim 21, wherein the specifying step selects a font in consideration with an order of specifying typeface attributes.

28. A program according to claim 21, wherein, when a typeface name is specified, the specifying step creates a list based on the typeface name and installed fonts and specifying a font based on the created list and the text code, and
wherein, when no typefaces are specified, the specifying step creates a list based on the attribute and stored fonts and specifies a font based on the created list and the text code.

29. A program according to claim 21, wherein, when a typeface name is specified, the specifying step creates a list based on the typeface name and installed fonts and wherein, when no fonts are specified based on the created list and the text code, the specifying step creates a list based on the attribute and stored fonts and specifies a font based on the created list and the text code.

30. A program according to claim 21, the output device includes a printer.
